(19) United States
(12) Patent Application Publication
(10) Pub. No.: US 2012/0183788 A1
(43) Pub. Date: Jul. 19, 2012

(54) SILICON CARBIDE CERAMIC MATRIX COMPOSITES, HYBRID CERAMIC MATERIALS AND METHODS OF MAKING THE SAME

(75) Inventors: Gregory Scot Corman, Ballston Spa, NY (US); Peter Joel Meschter, Niskayuna, NY (US); Krishan Lal Luthra, Niskayuna, NY (US)

(73) Assignee: General Electric Company, Schenectady, NY (US)

(21) Appl. No.: 12/358,069

(22) Filed: Jan. 22, 2009

(51) Int. Cl. B32B 9/04; B05D 1/36; B29C 63/00

(52) U.S. Cl. 428/446; 264/279; 427/402

(57) ABSTRACT

Silicon carbide ceramic matrix composites, and hybrid ceramic materials are provided. In one embodiment, the silicon carbide composites comprise reinforcement material further comprising a simplified coating, and in others, the composites comprise uncoated reinforcement material. The hybrid ceramic materials comprise at least two of a conventional ceramic matrix composite, a monolithic ceramic, the composite comprising uncoated reinforcement material, and the composite comprising reinforcement material comprising a simplified coating. Methods of providing the composites are also provided.

### STATEMENT REGARDING FEDERALLY SPONSORED RESEARCH & DEVELOPMENT

This invention was made with Government support under contract number DE-FC26-92CE41000 awarded by US Department of Energy. The Government has certain rights in the invention.

### BACKGROUND

Ceramic matrix composite (CMC) materials generally comprise a ceramic fiber reinforcement material embedded in a ceramic matrix material. The reinforcement material serves as the load-bearing constituent of the CMC in the event of a matrix crack, while the ceramic matrix protects the reinforcement material, maintains the orientation of its fibers, and serves to transfer loads to the reinforcement material. Of particular interest for high-temperature applications are silicon-based composites, such as those comprising silicon carbide (SiC) as the matrix and/or reinforcement material.

CMC's are expensive, owing both to the cost of the materials used to fabricate them and to the fabrication methods. Reinforcement materials, in particular, can be costly to manufacture, whether in the form of fibers or tows. In conventional CMC's, the individual fibers are typically coated with a plurality of materials and/or layers, applied by chemical vapor deposition (CVD), to provide the reinforcement materials with desirable mechanical properties and/or to enhance their processability. CVD is an inherently expensive process, and the fiber handling required to apply multilayer CVD coatings can result in substantial fiber or tow damage. However, monolithic ceramics, i.e., ceramics not comprising reinforcement materials, typically do not exhibit adequate mechanical properties to render them useful in typical applications, e.g. hot gas path components such as combustor liners, shrouds, buckets (blades), or nozzles (vanes) in gas turbines or jet engines.

It is desirable to provide CMC's or hybrid ceramic materials that provide reduced processing complexity and/or component cost. It would be further advantageous if the provided CMC's or hybrid ceramic materials would exhibit mechanical properties required for typical applications. Due to their applicability to high temperature applications, any such CMC's or hybrid ceramic materials would desirably comprise silicon carbide.

### BRIEF DESCRIPTION

There is provided a silicon carbide hybrid ceramic material comprising at least two of monolithic ceramic, a ceramic matrix composite, a ceramic matrix composite comprising uncoated reinforcement material and a ceramic matrix composite comprising reinforcement material coated with a simplified coating.

In another aspect, there is provided a silicon carbide ceramic matrix composite comprising uncoated reinforcement material.

In another aspect, there is provided a silicon carbide ceramic matrix composite comprising reinforcement material coated with a simplified coating.

In another aspect, there is provided a method for making a melt-infiltrated silicon carbide ceramic matrix composite wherein the method does not comprise coating a reinforcement material.

In yet another aspect, there is provided a method for making a melt-infiltrated silicon carbide ceramic matrix composite wherein the method comprises a simplified coating process.

### DRAWINGS

These and other features, aspects, and advantages of the invention will become better understood when the following detailed description is read with reference to the accompanying drawings in which like characters represent like parts throughout the drawings, wherein:

FIG. 1 is a cross-sectional view of a CMC as provided herein;

FIG. 2 is a photograph of a conventional CMC plate made with coated Hi-Nicalon fiber after ballistic impact testing;

FIG. 3 is a photograph of a conventional CMC plate made with coated Hi-Nicalon type S fiber after ballistic impact testing;

FIG. 4 is a photograph of a sintered Si₃N₄ (Kyocera SN-282) monolithic ceramic plate after ballistic impact testing; and

FIG. 5 is a photograph of a CMC plate according to one embodiment, made with uncoated Hi-Nicalon fiber, after ballistic impact testing.

### DETAILED DESCRIPTION

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

Novel silicon carbide ceramic matrix composites and hybrid ceramic materials are provided herein. The composites comprise a ceramic matrix material comprising SiC and a SiC ceramic reinforcement material within the composite. In some embodiments, a percentage of the reinforcement material is uncoated, and in others, a percentage of the reinforcement material is coated, but with a simplified coating as compared to state of the art multicomponent coatings.

In addition to either or both of the silicon carbide ceramic matrix composites described above, the hybrid ceramic materials may further comprise monolithic ceramics and/or conventional silicon carbide ceramic matrix composites, i.e., those comprising SiC reinforcement material coated with a conventional coating and/or by a conventional coating process. More particularly, the hybrid ceramic materials comprise at least two of a monolithic ceramic, a conventional ceramic matrix composite, a composite comprising uncoated reinforcement material, and/or a composite comprising reinforcement material wherein at least a portion of the reinforcement material is uncoated. As used herein, the phrase ‘monolithic ceramic’ refers to a ceramic with substantially no mechanical reinforcement. Methods of making the composites are also provided.

The CMC's take advantage of the discovery that silicon carbide CMC's with suitable toughness for selected applications can be provided that comprise material with uncoated reinforcements, or material containing reinforcements coated with a simplified coating as compared to conventional silicon carbide CMC's. That is, the fiber reinforcements in conventional silicon carbide CMC's may typically be coated with at least four layers and/or four active components present in any number of layers. Namely, fiber reinforcements in conventional silicon carbide CMC's may typically incorporate layers comprising boron nitride (BN), silicon doped boron nitride (Si-doped BN), silicon nitride (Si₃N₄) and carbon (C), via a chemical vapor deposition process. Such CVD processes not only add significantly to the cost of the silicon carbide CMC fabrication process, but also can damage the fiber reinforcement material. The coating materials themselves can also be costly, and reducing the amounts used in one or more coating layers can provide cost savings while providing CMC's with acceptable properties for selected applications.

As used herein, the phrase “simplified coating” indicates a coating applied to fiber reinforcements with fewer than the conventional number of layers, and/or coatings that may be applied in a lesser number of steps, as compared to fiber reinforcement coatings typically utilized in conventional silicon carbide CMC's.

It has now been discovered that silicon carbide CMC's containing uncoated reinforcement fibers, while brittle and of low toughness when tested by normal low strain rate tests, can show enhanced damage tolerance with respect to monolithic ceramics when tested at high strain rates or in tests of foreign object damage (FOD) resistance. While not optimal for use in all applications, silicon carbide CMC's containing uncoated reinforcement fibers are particularly well suited for applications where high-velocity or ballistic impact may be expected. One example of such an application is in gas turbine components, where foreign object damage (FOD) events are likely.

Also contemplated are silicon carbide CMC's containing reinforcements with simplified coatings as compared to those in conventional silicon carbide CMC's. CMC's according to this embodiment are expected to provide properties, such as toughness and FOD resistance, intermediate between those of conventional silicon carbide CMC's and silicon carbide CMC's containing uncoated reinforcements.

Reducing or eliminating the fiber coating step in the manufacture of fiber-reinforced CMC's significantly reduces the overall CMC fabrication cost. Although reducing the number of layers or reducing the number of steps in the fiber reinforcement coating process can lead to chemical bonding of the fibers to the CMC matrix during processing, such that the resulting simplified silicon carbide CMC's perform similarly to monolithic ceramics in low strain rate tests, the simplified SiC CMC's can show greatly enhanced toughness and FOD resistance when compared to monolithic ceramics.

In one embodiment, silicon carbide ceramic matrix composites are provided wherein a percentage of the SiC fiber reinforcements therein are uncoated. 100% of the fiber reinforcement materials may be uncoated, or a lesser percentage typically ranging from about 0.01% to about 100%, or from about 10% to about 90%, by volume. It is to be understood that any of the limits or ranges specified herein are inclusive of all amounts or subranges below or within.

In another embodiment, a percentage of the fiber reinforcements in a SiC CMC are provided with a simplified coating as compared to fiber reinforcement coatings in conventional SiC CMC's. As used herein, the phrase ‘simplified coating’ is meant to indicate any coating capable of being formulated or deposited at reduced cost and/or with fewer processing steps than a conventional, e.g., a four-layer BN/Si-doped BN/Si₃N₄/C, fiber reinforcement coating.

As compared to conventional fiber reinforcement coatings that may typically include BN, Si-doped BN, Si₃N₄ and C, one example of a CMC according to this embodiment might comprise fewer layers, e.g., BN, Si-doped BN and C; or BN, Si-doped BN and Si₃N₄; BN and Si-doped BN; etc, so that fewer processing steps are required to deposit the simplified coating.

Also provided are hybrid SiC ceramic materials that in some embodiments, comprise the simplified SiC CMC's provided herein. It has now additionally been discovered that another way of providing materials acceptable for use in applications where toughness greater than that exhibited by, e.g., monolithic ceramics, is to provide hybrid ceramic materials. Hybrids comprising conventional SiC CMC's and monolithic ceramics are contemplated, and are expected to provide intermediate properties to those provide by the conventional SiC CMC or monolithic ceramic when utilized alone. Hybrids utilizing two or more of either a conventional SiC CMC or monolithic ceramic and either of the simplified SiC CMC's disclosed herein are also contemplated and are similarly expected to provide properties intermediate to those exhibited by the composites or monolithic utilized in the hybrid when any of these materials utilized alone.

The hybrid SiC CMC's taught herein may comprise any materials suitably included in conventional SiC CMC's. Preferred materials for use as the matrix material are those comprising SiC disclosed in commonly-assigned U.S. Pat. Nos. 5,015,540, 5,330,854, 5,336,350, 5,628,938, 6,024,898, 6,258,737, 6,403,158, and 6,503,441, and commonly-assigned U.S. Patent Application Publication No. 2004/0067316, whose disclosures relating to compositions and processing of CMC's are incorporated herein by reference.

As those of ordinary skill in the art are aware, the fibers in CMC materials may be provided as relatively continuous fibers, or tows, that may be arranged to form a unidirectional array of fibers, a cross-plied array of fibers, or bundled in tows that are arranged to form a unidirectional array of tows, or that are woven or cross-plied to form a two-dimensional array, or that are woven or braided to form a three-dimensional fabric. For three-dimensional fabrics, sets of unidirectional tows may, for example, be interwoven transverse to each other. It is to be understood that reference herein to coated fibers is understood to include relatively continuous fibers, as well as such fibers bundled, woven or braided together to form tows, and thus, that ceramic composites including these, referred to in the art as continuous fiber reinforced ceramic composite (CFCC) materials, are considered to be within the scope of the disclosure.

The fibers or tows utilized in the simplified SiC CMC's taught herein desirably comprise any SiC fibrous material suitably utilized in conventional SiC CMC's. Composites or hybrids comprising such fibers within a silicon-silicon carbide matrix may typically be referred to as a SiC/Si—SiC (fiber/matrix) CMC's. One example of a commercial material suitable for the fibers/tows is HI-NICALON® from Nippon Carbon Co., Ltd. Those skilled in the art will appreciate that the teachings of this invention are also applicable to other fiber/fiber coating/matrix combinations commonly used in CMC's, and that such combinations are within the scope of this invention.

In some embodiments, the fracture toughness or FOD resistance of the simplified SiC CMC's may be sufficient for the application without combining such simplified SiC CMC's with conventional CMC's; in other embodiments, it may be desirable to provide the simplified SiC CMC's in combination with each other, with conventional CMC's and/or with monolithic ceramics, to provide hybrid SiC ceramic matrix composite materials with properties intermediate to those of any of these materials alone. For example, for use in applications where increased toughness of the CMC is desirable, hybrid structures incorporating sections of SiC CMC with coated SiC fiber in combination with sections made with uncoated SiC fiber would provide toughness under high strain rate or FOD conditions similar to that of conventional CMC structures, but at reduced cost. In other embodiments, hybrid structures can include sections of SiC CMC's with uncoated fiber reinforcements in combination with sections of SiC CMC's with fiber reinforcements with simplified coatings and/or sections of monolithic ceramic or conventional CMC's.

The sections of such hybrid structures can be provided as layers, in any number, configuration and combination. For example, the hybrid structures of SiC CMC's containing uncoated fibers and conventional CMC's with multilayer fiber coatings can include layered structures with SiC CMC's containing uncoated fibers on the inside, e.g., as an insert, or on the outside, e.g., as surface layers.

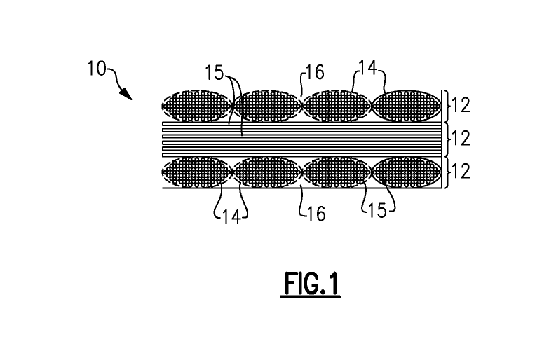

One example of a SiC CMC according to the invention is shown in FIG. 1. As shown, CMC 10 comprises multiple layers 12, each derived from an individual prepreg tape, or similar essentially two-dimensional body, that comprises unidirectionally-aligned tows 14 impregnated within a ceramic matrix precursor. As a result, each layer 12 contains unidirectionally-aligned fibers 15 encased in a ceramic matrix 16 formed by conversion of the ceramic matrix precursor during processing. As discussed above, each of layers 12 may independently comprise substantially no coating on the tows therein, may comprise a simplified coating on the tows therein, or, at least one layer may comprise tows uncoated or coated with a simplified coating, or may comprise a conventional coating on the tows therein.

The simplified SiC CMC's can be fabricated according to any known, suitable technique for making CMC's, wherein any fiber coating step(s) previously required are advantageously simplified, reduced in number, or eliminated. In particular, the simplified SiC CMC's can be fabricated advantageously with regions of fiber reinforcements that have been coated by a simplified process, or that have not been coated. One technique for fabricating CMC's involves multiple layers of “prepreg,” often in the form of a tape-like structure, comprising the fiber reinforcement of the desired CMC impregnated with a precursor of the CMC matrix material. Multiple prepregged plies are stacked and debulked to form a laminate perform. Following lay-up, the laminate preform may typically undergo debulking and curing while being subjected to applied pressure and an elevated temperature, such as in an autoclave.

Melt infiltration processes can be a preferred method of manufacturing CMC's, since they produce CMC's with the high thermal conductivity required to handle thermal stresses. In addition, melt infiltration provides high matrix cracking strength. In the case of melt-infiltrated (MI) CMC articles, the debulked and cured preform undergoes additional processing. First the preform is heated in vacuum or in an inert atmosphere in order to decompose the organic binders, at least one of which pyrolyzes during this heat treatment to form a carbon char, and produces a porous preform for melt infiltration. During further heating, either as part of the same heat cycle as the binder burn-out step or in an independent subsequent heating step, the preform is melt infiltrated, such as with molten silicon supplied externally. The molten silicon infiltrates into the porosity, reacts with the carbon constituent of the matrix to form silicon carbide, and fills the porosity to yield the desired CMC component.

Examples of SiC/S—SiC (fiber/matrix) CFCC materials and processes are disclosed in commonly-assigned U.S. Pat. Nos. 5,015,540, 5,330,854, 5,336,350, 5,628,938, 6,024,898, 6,258,737, 6,403,158, and 6,503,441, and commonly-assigned U.S. Patent Application Publication No. 2004/0067316, all of which being incorporated by reference herein for any and all purposes.

### Example 1

Ballistic impact tests, designed to simulate FOD events, were conducted on CMC plates fabricated using conventional CMC fiber coating and processing, monolithic ceramic plates comprising silicon nitride (Si₃N₄), and CMC plates fabricated using uncoated CMC fibers. More particularly, testing was conducted on prepreg melt infiltrated CMC's made with coated Hi-Nicalon and Hi-Nicalon type S fibers, a simplified CMC made using the normal CMC fabrication process but utilizing uncoated Hi-Nicalon fiber, and an engineering grade of sintered Si₃N₄ (Kyocera SN-282), all samples being nominally 0.1″ thick.

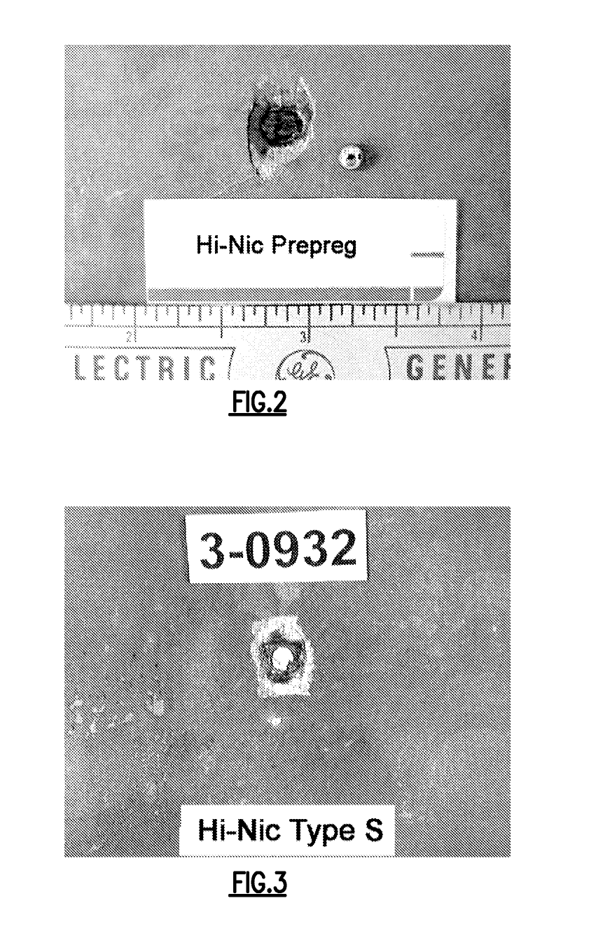

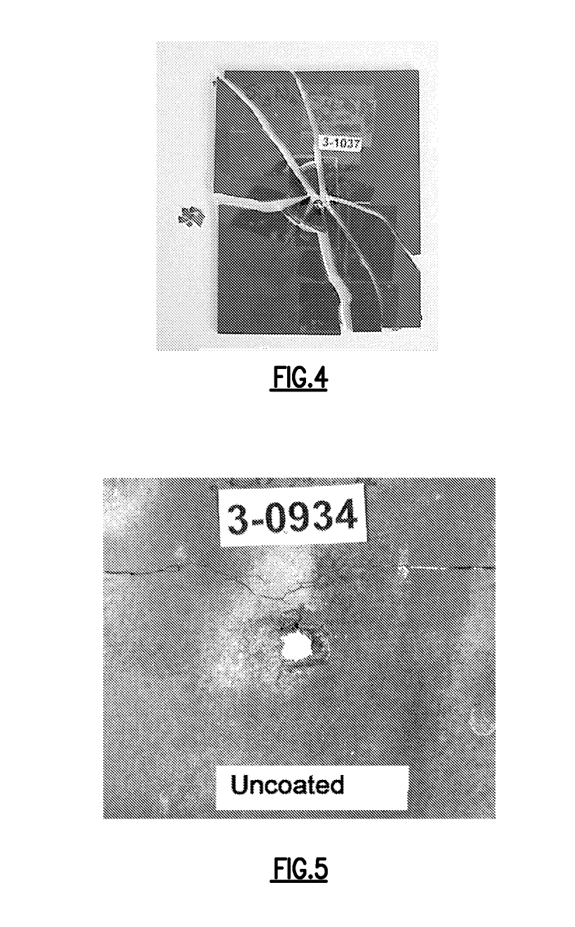

Impact testing was performed at 1200° C. using a 4 mm chromed steel ball bearing as a projectile at nominal velocities of 427 m/s and at 116-121 m/s. As shown in FIGS. 2 and 3, respectively, the normal CMC samples fabricated using coated Hi-Nicalon or coated Hi-Nicalon type S fiber showed complete penetration of the panel by the projectiles at both velocities, but the damaged region was limited to ˜3×-4× the size of the projectile itself. As shown in FIG. 4, the monolithic Si₃N₄ panel showed catastrophic brittle fracture even at the lower projectile velocity, breaking into numerous fragments upon impact. Other monolithic ceramics that would normally be used as inserts in CMC components, such as sintered or reaction bonded SiC, have even lower fracture toughness than Si₃N₄, and thus would shatter under even lower impact energy conditions than did the Si₃N₄. As shown in FIG. 5, the panel made with uncoated Hi-Nicalon fiber had a response very similar to that of the coated fiber CMC samples. The damaged zones in the uncoated fiber samples were slightly larger than those in the normal CMC samples, and at the lower velocity a full-width crack was observed, but the samples did not shatter into fragments as did the Si₃N₄ plates.

The results of this experiment indicate that the material made with uncoated Hi-Nicalon fiber has resistance to ballistic FOD comparable to that of the conventional CMC materials, even though it exhibits brittle fracture behavior when tested under tensile testing conditions at a low strain rate. Since the material with uncoated fiber reinforcements has been fabricated without the complex and costly fiber coating step, the cost of this material would be significantly lower than the cost of a normal CMC.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A silicon carbide hybrid ceramic material comprising at least two of a monolithic ceramic, a ceramic matrix composite, a ceramic matrix composite comprising uncoated reinforcement material and a ceramic matrix composite comprising reinforcement material coated with a simplified coating.

2. The hybrid ceramic material of claim 1, comprising at least three of monolithic ceramic, a ceramic matrix composite, a ceramic matrix composite comprising uncoated reinforcement material and a ceramic matrix composite comprising reinforcement material coated with a simplified coating.

3. The hybrid ceramic material of claim 2, comprising a monolithic ceramic, a ceramic matrix composite, a ceramic matrix composite comprising uncoated reinforcement material and a ceramic matrix composite comprising reinforcement material coated with a simplified coating.

4. The hybrid ceramic material of claim 1, 2 or 3, wherein from about 0.01% to about 100% of the uncoated reinforcement material is uncoated.

5. The hybrid ceramic material of claim 4, wherein substantially all of the reinforcement material is uncoated.

6. The hybrid ceramic material of claim 1, 2 or 3, wherein from about 0.01% to about 100% of the reinforcement material is coated with a simplified coating.

7. The hybrid ceramic material of claim 6, wherein substantially all of the reinforcement material is coated with a simplified coating.

8. The hybrid ceramic material of claim 7, wherein the simplified coating comprises a lesser number of layers, a lesser number of active components, and/or can be formed in a lesser number of steps, than conventional reinforcement coatings.

9. A silicon carbide ceramic matrix composite comprising uncoated reinforcement material.

10. The composite of claim 9, wherein from about 0.01% to about 100% of the reinforcement material is uncoated.

11. The composite of claim 10, wherein substantially all of the reinforcement material is uncoated.

12. A silicon carbide ceramic matrix composite comprising reinforcement material coated with a simplified coating.

13. The composite of claim 12, wherein the simplified coating comprises a lesser number of layers, a lesser number of active components, and/or can be formed in a lesser number of steps, than a conventional reinforcement coating.

14. The composite of claim 13, wherein from about 0.01% to about 100% of the reinforcement material comprises the simplified coating.

15. The composite of claim 14, wherein substantially all of the reinforcement material comprises the simplified coating.

16. A method for making a melt-infiltrated silicon carbide ceramic matrix composite wherein the method does not comprise coating a reinforcement material.

17. A method for making a melt-infiltrated silicon carbide ceramic matrix composite wherein the method comprises a simplified coating process.

18. The method of claim 17, wherein the simplified coating process comprises a smaller number of steps than a conventional coating process.

19. The method of claim 18, wherein the simplified coating process comprises applying a smaller number of coating layers than a conventional coating process.
